(19) United States
(12) Patent Application Publication
(10) Pub. No.: US 2016/0247618 A1
(43) Pub. Date: Aug. 25, 2016

(54) SUBSEA TRANSFORMER WITH INTEGRATED HIGH RESISTANCE GROUND

(71) Applicant: ONESUBSEA IP UK LIMITED, London (GB)

(72) Inventor: Asbjoern Diesen, Bergen (NO)

(21) Appl. No.: 14/631,676

(22) Filed: Feb. 25, 2015

(51) Int. Cl. H01F 27/02; H01F 27/28

(52) U.S. Cl. CPC H01F 27/02; H01F 27/28

(57) ABSTRACT

According to some embodiments, a subsea transformer is protected by an integrated high resistance grounding (HRG) device. The active components, including primary and secondary sets of windings for the transformer are mounted in an oil-filled transformer tank that is suitable for long-term deployment in a subsea environment. The HRG device is mounted in the same oil-filled transformer tank as the active transformer components.

### TECHNICAL FIELD

The present disclosure relates to subsea power transformers. More particularly, the present disclosure relates to three-phase subsea power transformers having high resistance grounding systems.

### BACKGROUND

In the subsea oil and gas industry, it is often desirable to perform certain fluid processing activities on the sea floor. Examples include fluid pumps (both single phase and multiphase) and compressors (both gas compressors and “wet gas” compressors). The subsea pumps and compressors are commonly driven with electric motors, which are supplied by three-phase electrical power via one or more umbilical cables from a surface facility. Especially in cases where the umbilical cable is relatively long, it is desirable to transmit the electrical power at higher voltages through the umbilical cable and use a subsea transformer to step-down to a voltage suitable for use by the subsea electric motors.

High resistance grounding (HRG) is a principle that is well known and has been used in medium voltage distribution transformer systems. The purpose of the HRG is two fold: (1) to clamp the otherwise isolated neutral point of the transformer to ground; and (2) limit possible ground fault current to a low and well defined level. In normal operation, the vector sum of the capacitive currents between the three live symmetrical phases will be zero and no current will flow in the HRG from the transformer neutral point. With an earth fault present in one of the phases, the two healthy phases will have the correct line voltage values relative to each other both in magnitude and in phase, although they will be shifted in voltage. In subsea installations, the HRG unit has been provided by a solid resistive element located in a separate compartment from the main transformer windings. FIGS. 10 and 11 are schematic diagrams illustrating aspects of subsea transformers with known HRG protection techniques.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A subsea transformer protected by high resistance grounding is described. The transformer includes: a primary set of coil windings; a secondary set of coil windings; a subsea transformer tank defined by a tank wall and housing the primary and secondary sets of coil windings and a transformer oil which bathes the primary and secondary sets of coil windings. The tank wall is suitable for long-term deployment in a subsea environment. The transformer further includes a high resistance grounding device mounted within the transformer tank and being bathed in the transformer oil. The high resistance grounding device includes: a first terminal electrically connected to a neutral node of the secondary set of coil windings; and a second terminal electrically connected to a ground. The high resistance grounding device is configured to provide a high electrical resistance path between the first and second terminals.

According to some embodiments, the outer surface of the tank wall is exposed to seawater and the inner surface of the tank wall is exposed to the transformer oil. According to some embodiments, the high resistance electrical path has a resistance of at least 1000 ohms. The high resistance electrical path can include a plurality of high resistance elements electrically interconnected in series. The plurality of high resistance elements can be grouped into a plurality of banks, each of which is mounted to a frame member of the transformer. The frame member can be above or below the primary and secondary sets of coil windings.

According to some embodiments, the subsea transformer is a step-down transformer, with the primary set of windings interconnected in a delta arrangement, and the secondary set of windings interconnected in a wye arrangement. The first and second terminals can be electrically connected to the neutral node and to ground (e.g. the tank wall), respectively, via low resistance electrical paths.

According to some embodiments, the transformer is configured to supply power to one or more subsea motors used for processing hydrocarbon bearing fluids produced from a subterranean rock formation. The subsea motor(s) can be configured for driving one or more subsea pumps, compressors or separators.

### BRIEF DESCRIPTION OF THE DRAWINGS

The subject disclosure is further described in the detailed description which follows, in reference to the noted plurality of drawings by way of non-limiting examples of embodiments of the subject disclosure, in which like reference numerals represent similar parts throughout the several views of the drawings, and wherein:

FIG. 1 is a diagram illustrating a subsea environment in which a subsea transformer using an integrated HRG device is deployed, according to some embodiments;

FIG. 2 is a cut-away diagram showing various components of a subsea transformer employing an integrated HRG device, according to some embodiments;

FIG. 3 is a schematic diagram showing further aspects of a subsea transformer employing an integrated HRG device, according to some embodiments;

FIGS. 4 and 5 are perspective and plan views, respectively, of a single resistor bank that forms part of an integrated high resistance grounding system for a subsea transformer, according to some embodiments;

FIG. 6 is a schematic diagram illustrating some aspects of a multi-bank integrated high resistance grounding system for use with a subsea transformer, according to some embodiments;

FIG. 7 is a cut-away diagram showing some internal portions of a subsea transformer protected by integrated high resistance grounding, according to some embodiments; and

FIGS. 8 and 9 are schematic diagrams illustrating aspects of subsea transformers with known HRG protection techniques.

### DETAILED DESCRIPTION

The particulars shown herein are by way of example, and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details of the subject disclosure in more detail than is necessary for the fundamental understanding of the subject disclosure, the description taken with the drawings making apparent to those skilled in the art how the several forms of the subject disclosure may be embodied in practice. Further, like reference numbers and designations in the various drawings indicate like elements.

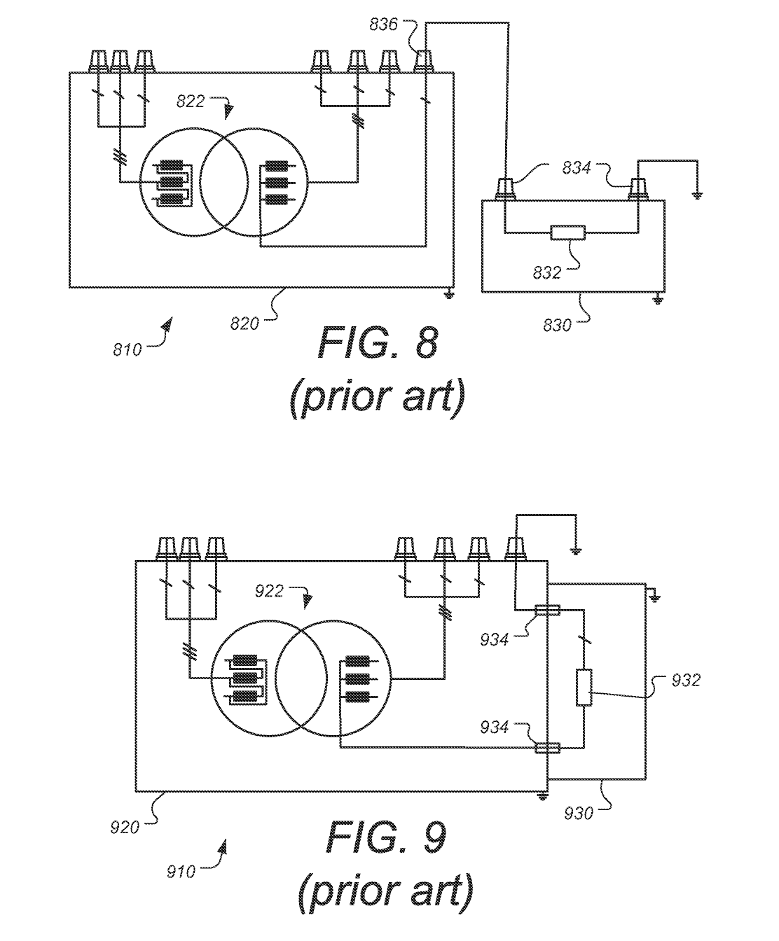

Prior art transformer designs, such as shown in FIGS. 8 and 9, provide HRG protection using a separate compartment. Such designs have a number of drawbacks that are addressed by at least some embodiments described herein. By integrating the HRG device within the same oil-filled tank as the active transformer components, a substantial reduction in overall size and volume of the transformer module can be obtained. Since no additional compartment is used, the HRG capability can be more easily used in connection with existing transformer designs. By reducing the number of feedthroughs, or penetrations in the tank wall, there are fewer sources of potential failure and thus reliability can be increased. By using the same oil as the transformer, cooling of the HRG can be managed in common with the cooling of the transformer compartment.

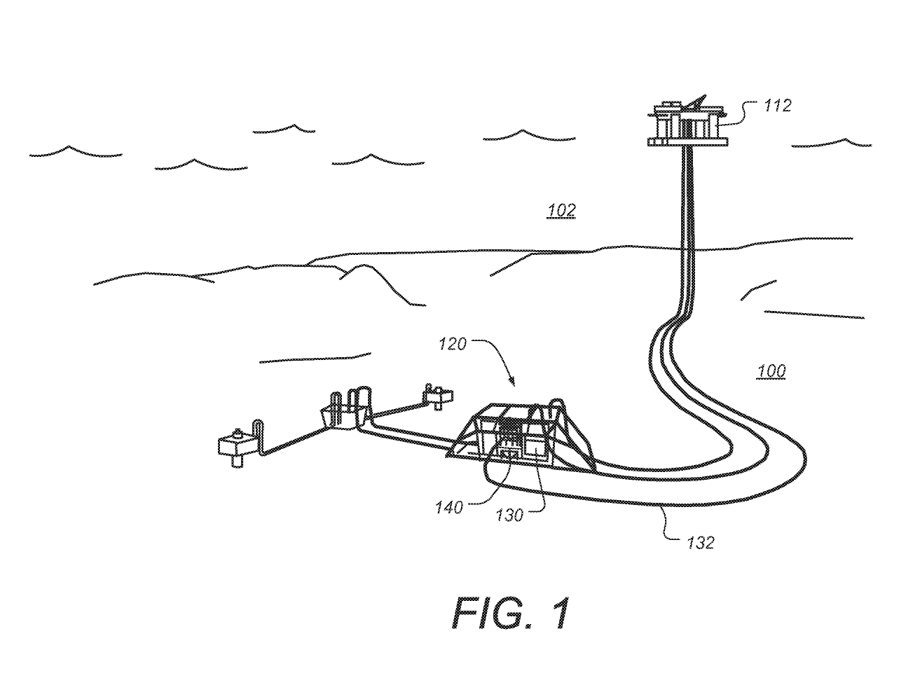

FIG. 1 is a diagram illustrating a subsea environment in which a subsea transformer using an integrated HRG device is deployed, according to some embodiments. On sea floor 100 a station 120 is shown which is downstream of several wellheads being used, for example, to produce hydrocarbon-bearing fluid from a subterranean rock formation. Station 120 includes a subsea pump module 130, which has a pump (or compressor) that is driven by an electric motor. The station 120 is connected to one or more umbilical cables, such as umbilical 132. The umbilicals in this case are being run from a platform 112 through seawater 102, along sea floor 100 and to station 120. In other cases, the umbilicals may be run from some other surface facility such as a floating production, storage and offloading unit (FPSO), or a shore-based facility. In many cases to reduce energy losses, it is desirable to transmit energy through the umbilicals at higher voltages than is used by the electric motor in pump module 130. Station 120 thus also includes a step-down transformer 140, which converts the higher-voltage three-phase power being transmitted over the umbilical 132 to lower-voltage three-phase power for use by pump module 130. In addition to pump module 130 and transformer 140, the station 120 can include various other types of subsea equipment, including other pumps and/or compressors. The umbilical 132 can also be used to supply barrier and other fluids, and control and data lines for use with the subsea equipment in station 120. Note that although transformer 140 is referred to herein as a three-phase step-down transformer, the techniques described herein are equally applicable to other types of subsea transformers such as having other numbers of phases, and being of other types (e.g. step-up transformer).

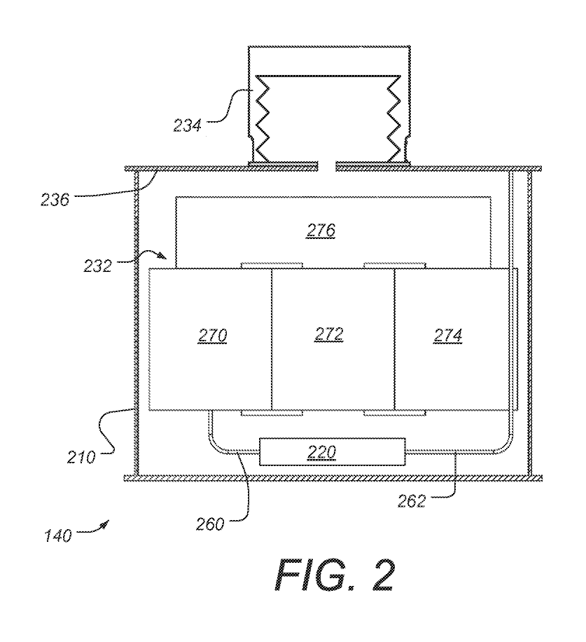

FIG. 2 is a cut-away diagram showing various components of a subsea transformer employing an integrated HRG device, according to some embodiments. Subsea transformer 140 includes a tank wall 210. Inside the transformer tank is the active portion 232 of the transformer, which includes the primary and secondary windings 270, 272 and 274 for the three phases as well as the transformer core 276. Tank compensator 234 is used to compensate the transformer tank volume for pressure changes due to temperature fluctuations. The active portion 232 is sealed in the transformer tank by the tank wall 210 and the tank lid 236. According to some embodiments, subsea transformer 140 is a two-tank design using double barriers such as described in further detail in co-pending U.S. patent application Ser. No. 14/631,649, filed on Feb. 25, 2015, entitled “Fault Tolerant Subsea Transformer”, which is herein incorporated by reference in its entirety.

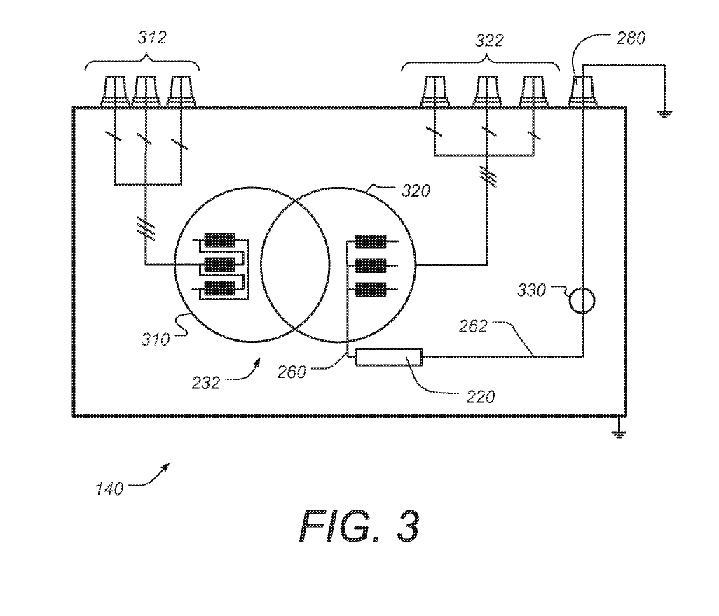

Also visible in FIG. 3 is neutral conductor 260 is directly connected to the neutral node of the secondary winding for the three phases (i.e. which are arranged in a “wye” configuration). Neutral conductor 260 connects to integrated HRG device 220, which in this case is shown below the windings 270, 272 and 274. The HRG device 220 is electrically connected via conductor 262 to ground, which in this case is tank lid 236. Note that according to some embodiments, the transformer tank walls are grounded and are grounded through connection to an umbilical termination head (not shown), and up to the vessel or surface facility, such as platform 112 shown in FIG. 1.

FIG. 3 is a schematic diagram showing further aspects of a subsea transformer employing an integrated HRG device, according to some embodiments. In this diagram it can be seen that active portion 232 of subsea transformer 140 is arranged in a “delta” structure for the primary windings 310 and a “wye” structure for secondary windings 320. Also visible are primary phase bushings 312 and secondary phase bushings 322. The neutral conductor 260 is shown running from the neutral node of the secondary windings 320 to the integrated HRG device 220. Conductor 262 electrically connects integrated HRG device 220 to ground through a bushing 280. According to some embodiments, such as shown in FIG. 2, a separate bushing is not needed since the conductor 262 and HRG device 220 both reside on the inside of the transformer tank and can thus be connected to the inner surface of the transformer tank for grounding.

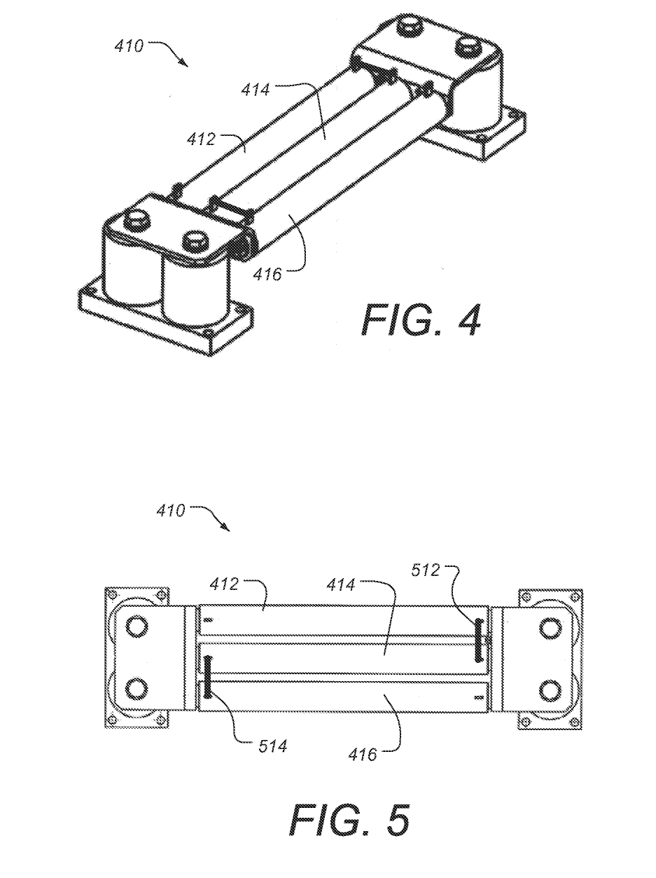

FIGS. 4 and 5 are perspective and plan views, respectively, of a single resistor bank that forms part of an integrated high resistance grounding system for a subsea transformer, according to some embodiments. Visible in FIGS. 4 and 5 is a single bank of resistor elements 410, which is made up of three individual resistive elements 412, 414 and 416. The resistive elements are electrically connected in series using jumpers 512 and 514.

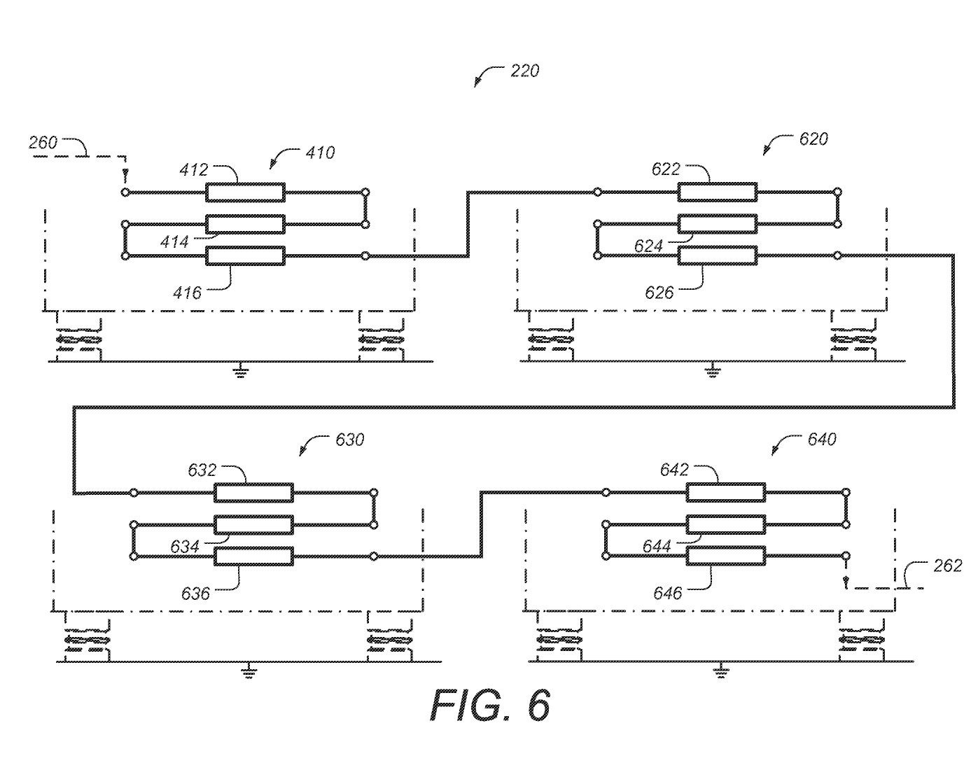

FIG. 6 is a schematic diagram illustrating some aspects of a multi-bank integrated high resistance grounding system for use with a subsea transformer, according to some embodiments. As shown, integrated HRG device 220 in this example includes four banks, 410, 620, 630 and 640 of resistors connected in series. Each of the banks includes 3 resistive elements. Bank 410 includes resistive elements 412, 414 and 416; bank 620 resistive elements 622, 624 and 626; bank 630 resistive elements 632, 634 and 7636; and bank 640 resistive elements 642, 644 and 646. Thus, in this example HRG device 220 is made up a total of 12 resistive elements connected in series. According to some embodiments, the total resistance provided by device 220 is about 3800 ohms, although that amount will depend on the particular application.

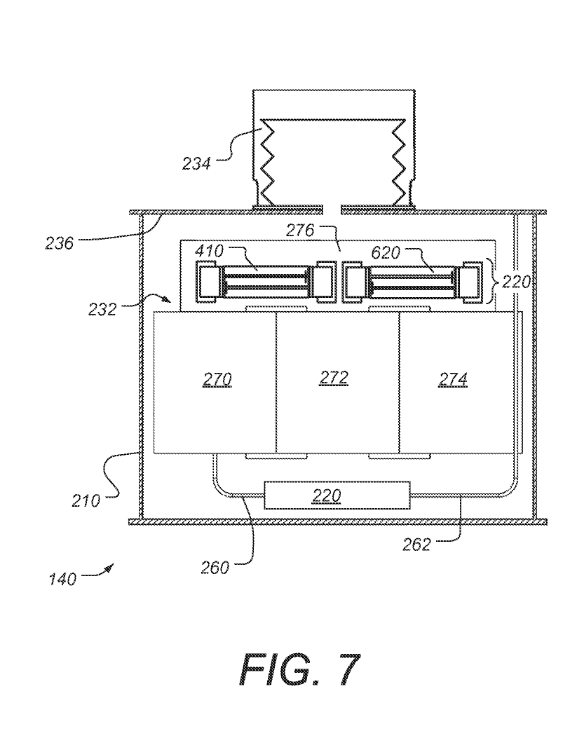

FIG. 7 is a cut-away view of some internal portions of a subsea transformer protected by integrated high resistance grounding, according to some embodiments. In this example, banks 410 and 620 of HRG device 220 is shown mounted to above the windings 270, 272 and 274. According to some other embodiments, some or all of the resistive banks can be mounted in other locations within the transformer tank. In another embodiment, for example, the banks 410, 620, 630 and 640 are mounted on a frame member below the windings.

According to some embodiments, a current sensor can be provided to allow for monitoring of a ground fault. For example, a current sensor 330 can be provided between HRG device 220 and ground as shown in FIG. 3. Signals from the sensor 330 can be converted to digital form and communicated to the surface by a monitoring system. For further details on such monitoring systems, refer to co-pending U.S. patent application Ser. No. 14/631,641, filed on Feb. 25, 2015, entitled “Monitoring Multiple Subsea Electric Motors”, which is herein incorporated by reference in its entirety.

FIGS. 8 and 9 are schematic diagrams illustrating aspects of subsea transformers with known HRG protection techniques. In FIG. 8, subsea transformer 810 includes a transformer tank 820 that houses active transformer components 822. The neutral node of the transformer is connected to separate high resistance ground unit 830 that includes high resistance element(s) 832. The high resistance grounding unit 832 is connected to the neutral node and ground via conductors passing through bushings 834 and 836. The layout of subsea transformer 910 in FIG. 9 is similar to that of transformer 810 in FIG. 8, except that the high resistance ground unit 930 is directly mounted to the outside of transformer tank 920. The high resistance element(s) 932 are electrically connected to ground and to the neutral node of the active transformer components 922 via bushings 934 and 936.

While the subject disclosure is described through the above embodiments, it will be understood by those of ordinary skill in the art that modification to and variation of the illustrated embodiments may be made without departing from the inventive concepts herein disclosed. Moreover, while some embodiments are described in connection with various illustrative structures, one skilled in the art will recognize that the system may be embodied using a variety of specific structures. Accordingly, the subject disclosure should not be viewed as limited except by the scope and spirit of the appended claims.

What is claimed is:

1. A subsea transformer protected by resistance grounding comprising:
a primary set of coil windings;
a secondary set of coil windings;
a subsea transformer tank defined by a tank wall and housing said primary and secondary sets of coil windings and a transformer fluid which bathes said primary and secondary sets of coil windings, said tank wall being suitable for deployment in a subsea environment; and
a resistance grounding device mounted within said transformer tank and being bathed in the transformer fluid, and comprising:
a first terminal electrically connected to a neutral node of said secondary set of coil windings; and
a second terminal electrically connected to a ground, said resistance grounding device configured to provide electrical resistance path between said first and second terminals.

2. The subsea transformer according to claim 1 wherein an outer surface of the tank wall is exposed to seawater and an inner surface of the tank wall is exposed to the transformer fluid.

3. The subsea transformer according to claim 1 wherein said resistance electrical path has a resistance of at least 1000 ohms.

4. The subsea transformer according to claim 1 wherein said resistance electrical path includes a plurality of resistance elements electrically interconnected in series.

5. The subsea transformer according to claim 4 wherein said plurality of resistance elements are grouped into a plurality of banks, each of which is mounted to a frame member of said transformer.

6. The subsea transformer according to claim 1 wherein the transformer fluid is an insulating transformer oil.

7. The subsea transformer according to claim 1 wherein the transformer is a step-down or a step-up transformer.

8. The subsea transformer according to claim 1 wherein the subsea transformer is a step-down transformer, said primary set of windings are interconnected in a delta arrangement, and said secondary set of windings are interconnected in a wye arrangement.

9. The subsea transformer according to claim 1 wherein said first and second terminals are electrically connected to said neutral node and said ground, respectively, via low resistance electrical paths.

10. The subsea transformer according to claim 1 wherein said ground is the tank wall.

11. The subsea transformer according to claim 1 wherein said transformer is configured to supply power to one or more subsea components used for processing hydrocarbon fluids produced from a subterranean rock formation.

12. The subsea transformer according to claim 11 wherein said one or more subsea components are motors configured for driving one or more subsea pumps, compressors or separators.
